(19) United States
(12) Patent Application Publication
(10) Pub. No.: US 2007/0237204 A1
(43) Pub. Date: Oct. 11, 2007

(54) Capacitive type temperature sensor

(75) Inventors: Sang-wook Kwon, Seongnam-si (KR); Young-hoon Min, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/217,433

(22) Filed: Sep. 2, 2005

(30) Foreign Application Priority Data
Sep. 3, 2004 (KR) 2004-70366

(51) Int. Cl. G01K 7/00

(52) U.S. Cl. 374/163

(57) ABSTRACT

A capacitive type temperature sensor includes a first electrode layer, a second electrode layer, a dielectric layer positioned between the first and second electrode layers and having a dielectric of which a volume is changed in response to a temperature change, and a temperature calculation unit calculating a temperature corresponding to an electric potential difference between the first and second electrode layers. Accordingly, the capacitive type temperature sensor has a good sensitivity of measuring the temperature and a good accuracy, does not consume a large amount of power, and allows a process of fabricating the same to be simplified.

### CROSS-REFERENCE TO RELATED APPLICATIONS

This application claims priority from Korean Patent Application No. 2004-70366 filed on Sep. 3, 2004 in the Korean Intellectual Property Office, the entire content of which is incorporated herein by reference.

### BACKGROUND OF THE INVENTION

1. Field of the Invention

The present invention generally relates to a temperature sensor. More particular, the present invention relates to a temperature sensor applicable to a micro electro mechanical system (MEMS).

2. Description of the Related Art

A MEMS technique implements mechanical components as electronic elements using a semiconductor process, which may be employed to design mechanical equipment having a micro-structure of several micrometers or less. It is expected that that the MEMS technique will bring a striking innovation to all industrial fields including electronic, mechanical, medical, and defense industries. Especially, sensors fabricated by the MEMS technique may be typically micro-fabricated, so that they are built in various small-sized devices such as a cellular phone to detect various information.

In recent years, a resistive type temperature sensor has been widely applied to the MEMS. This is because that it has a good sensitivity of measuring temperature and a good accuracy thereof. However, the resistive type temperature sensor consumes a large amount of power so that it is not suitable for wireless equipment, mobile equipment and so forth.

Unlike the resistive type temperature sensor, a capacitive type temperature sensor does not consume a large amount of power. A conventional capacitive type temperature sensor measures the temperature by using a property that displacement of bimetal is changed in response to the temperature change and the capacitance is changed in response to the changed displacement.

However, the conventional capacitive type temperature sensor has drawbacks that it has a poor sensitivity of measuring the temperature and a poor accuracy thereof. In addition, according to a process of fabricating the conventional capacitive type temperature sensor, an initial displacement is caused due to a residual stress, which causes a difficulty in carrying out calibration, so that the fabrication process is subjected to manufacturing difficulties.

### SUMMARY OF THE INVENTION

The present invention provides a capacitive type temperature sensor which has a good sensitivity of measuring a temperature and a good accuracy, does not consume a large amount of power, and has a simple fabrication process.

According to an aspect of the present invention, there is provided a temperature sensor, which includes: a first electrode layer; a second electrode layer; a dielectric layer positioned between the first and second electrode layers and having a dielectric of which a volume is changed in response to a temperature change; and a temperature calculation unit calculating a temperature corresponding to an electric potential difference between the first and second electrode layers.

A junction area between the dielectric and the first and second electrode layers is changed in response to the changed volume of the dielectric, and an electric potential difference between the first and second electrode layers is changed in response to the changed junction area.

In addition, the volume change in response to the temperature change of the dielectric is preferably linear.

Further, the dielectric may be one of toluene, octanol, propanol, ethanol, and methanol.

In addition, a first dielectric of which a volume is changed in response to the temperature change is disposed at one end of the dielectric layer and a second dielectric of which a volume is changed in response to the temperature change may be disposed at the other end of the dielectric layer.

A first junction area which is the junction area between the first dielectric and the first and second electrode layers is changed in response to the volume change of the first dielectric, a second junction area which is the junction area between the second dielectric and the first and second electrode layers is changed in response to the volume change of the second dielectric, and an electric potential difference between the first and second electrode layers is changed in response to the change of the first and second junction areas.

In addition, the volume change in response to the temperature change of the first dielectric, and the volume change in response to the temperature change of the second dielectric are linear.

The first dielectric may be one of toluene, octanol, propanol, ethanol, and methanol, and the second dielectric may be one of toluene, octanol, propanol, ethanol, and methanol.

In addition, the temperature calculation unit detects an electric potential difference between the first and second electrode layers, calculates a capacitance between the first and second electrode layers using the calculated electric potential difference, and calculates a temperature corresponding to the calculated capacitance.

### BRIEF DESCRIPTION OF THE DRAWINGS

The above and/or aspects of the present invention will be more apparent by describing exemplary embodiments of the present invention with reference to the accompanying drawings, in which:

FIG. 1 is a view illustrating a capacitive type temperature sensor in accordance with an exemplary embodiment of the present invention;

FIGS. 2A and 2B are views for explaining a principle of calculating a temperature of the capacitive type temperature sensor shown in FIG. 1;

FIG. 3 is a view illustrating a capacitive type temperature sensor in accordance with another exemplary embodiment of the present invention;

FIGS. 4A and 4B are views for explaining a principle of calculating a temperature of the capacitive type temperature sensor shown in FIG. 3; and

FIG. 5 is a view illustrating a capacitor of a capacitive type temperature sensor in accordance with still another exemplary embodiment of the present invention.

### DETAILED DESCRIPTION OF EXEMPLARY EMBODIMENTS OF THE INVENTION

Hereinafter, the present invention will be described in detail with reference to accompanying drawings.

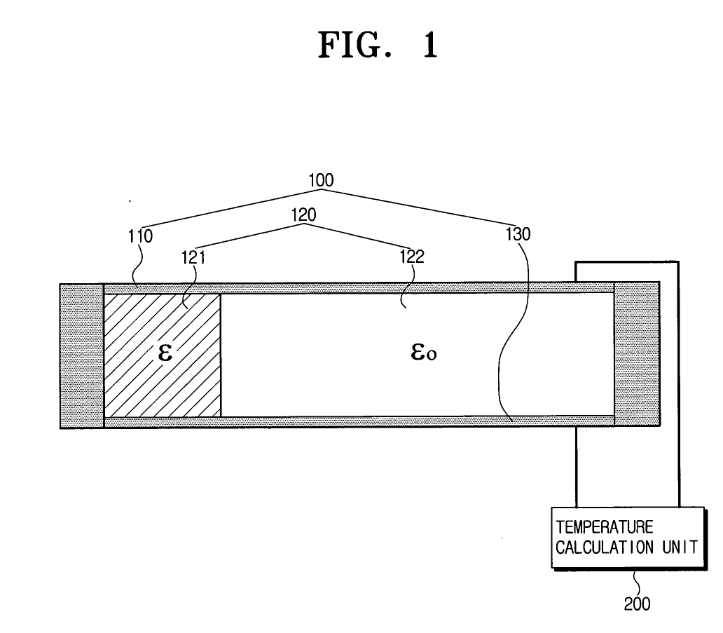

FIG. 1 is a view illustrating a capacitive type temperature sensor in accordance with an exemplary embodiment of the present invention. Referring to FIG. 1, the capacitive type temperature sensor includes a capacitor 100 and a temperature calculation unit 200.

The capacitor 100 includes a top electrode layer 110, a dielectric layer 120, and a bottom electrode layer 130.

The dielectric layer 120 is positioned between the top electrode layer 110 and the bottom electrode layer 130. The dielectric layer includes a dielectric 121 is disposed at a left end of the dielectric layer 120, and a vacuum space 122 is disposed at a right end of the dielectric layer 120. ∈ is a dielectric constant of the dielectric 121, and ∈₀ is a dielectric constant of the vacuum space 122.

The dielectric 121 is preferably, but not necessarily, implemented with a material (liquid or gas) having a big volume change in response to a temperature change, that is, a material having a high volume change rate, that is, a coefficient of thermal expansion, in response to the temperature change. In addition, the dielectric 121 is preferably, but not necessarily, implemented with a material having a linear volume change in response to the temperature change, that is, a material having a constant volume change rate in response to the temperature change. Examples of the material which has a high volume change and linear properties may include toluene (C₇H₈), octanol (CH₃(CH₂)₃OH), propanol (C₃H₈), ethanol (C₂H₅OH), methanol (CH₃OH), and so forth. Accordingly, the dielectric 121 is preferably implemented with any one of the above-described materials.

The temperature calculation unit 200 detects an electric potential difference between the top electrode layer 110 and the bottom electrode layer 130 and calculates a temperature corresponding to the detected electric potential difference. In this case, the temperature calculation unit 200 may calculate a capacitance of the capacitor 100 using the detected electric potential difference and calculate the temperature corresponding to the calculated capacitance.

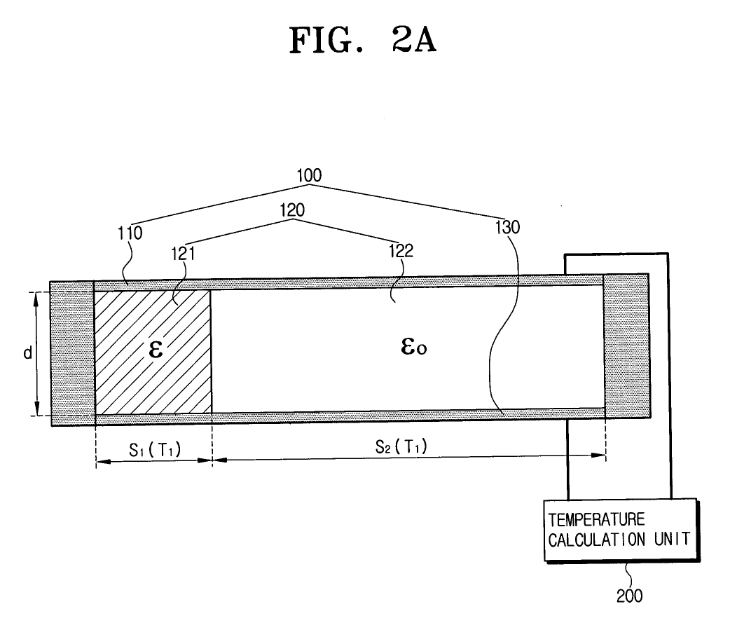

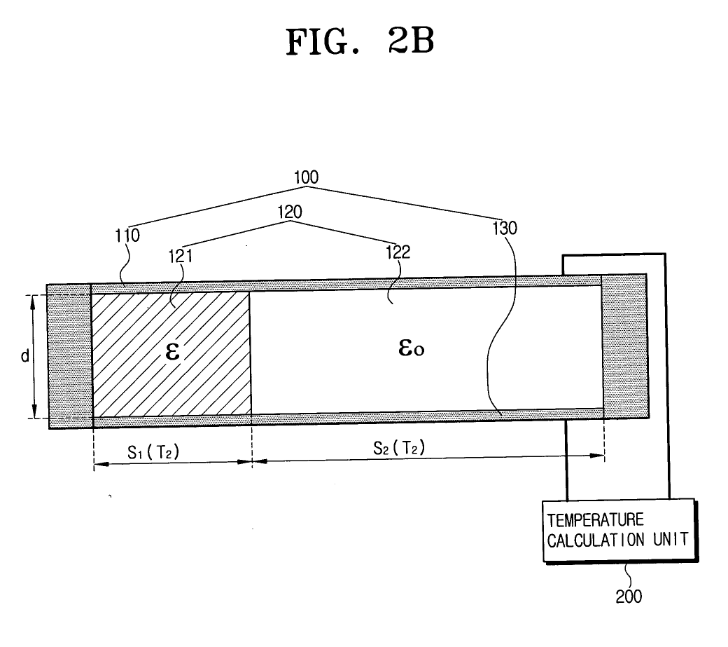

Hereinafter, a principle of calculating the temperature of the capacitive type temperature sensor shown in FIG. 1 will be described in detail with reference to FIGS. 2A and 2B.

FIG. 2A depicts the state of the exemplary capacitive type temperature sensor at a reference temperature T₁. Referring to FIG. 2A, a length between the top electrode layer 110 and the bottom electrode layer 130 is denoted by d, a junction area of the dielectric 121 and the top and bottom electrode layers 110 and 130 (hereinafter, referred to as a junction area of the dielectric 121) is denoted by S₁(T₁), and a junction area of the vacuum space 122 and the top and bottom electrode layers 110 and 130 (hereinafter, referred to as a junction area of the vacuum space 122) is denoted by S₂(T₁), at the reference temperature T₁.

In this case, a capacitance C_{T1} of the capacitor 100 (hereinafter, referred to as a capacitance), and an electric potential difference between the top and bottom electrode layers 110 and 130 V_{T1} (hereinafter, referred to as an electric potential difference) at the reference temperature T₁ may be determined as shown in Equation 1 below. In Equation 1, Q indicates an amount of charges of the top electrode layer 110 or the bottom electrode layer 130.

$${C}_{T 1} = ɛ \frac{{S}_{1} ( {T}_{1} )}{d} + {ɛ}_{0} \frac{{S}_{2} ( {T}_{1} )}{d} \\ {V}_{T 1} = \frac{Q}{{C}_{T 1}} \qquad [ Equation 1 ]$$

FIG. 2B depicts the state of the exemplary capacitive type temperature sensor when a temperature is increased from the reference temperature T₁ to a current temperature T₂ (i.e., T₂>T₁). Comparing FIG. 2A with FIG. 2B, the length d between the top and bottom electrode layers 110 and 130 is constant. However, it is noted that the junction area of the dielectric 121 is increased to S₁(T₂) (i.e., S₁(T₂)>S₁(T₁)) and the junction area of the vacuum space 122 is decreased to S₂(T₂) (i.e., S₂(T₂)<S₂(T₁)).

This is because the temperature is increased from the reference temperature T₁ to the current temperature T₂, which causes the volume of the dielectric 121 to be increased so that the junction area of the dielectric 121 is increased to S₁(T₂), and the volume of the dielectric 121 is increased to cause the volume of the vacuum space 122 to be relatively decreased so that the junction area of the vacuum space 122 is decreased to S₂(T₂.

In this case, a capacitance C_{T2} at the current temperature T₂ and an electric potential difference V_{T2} at the current temperature T₂ may be determined as follows in Equation 2.

$${C}_{T 2} = ɛ \frac{{S}_{1} ( {T}_{2} )}{d} + {ɛ}_{0} \frac{{S}_{2} ( {T}_{2} )}{d} \\ {V}_{T 2} = \frac{Q}{{C}_{T 2}} \qquad [ Equation 2 ]$$

When Equation 1 is compared with Equation 2, it can be understood that the capacitance C_{T2} of the current temperature T₂ is different from the capacitance C_{T1} of the reference temperature T₁. It can also be understood that the electric potential difference V_{T2} of the current temperature T₂ is different from the electric potential difference V_{T1} of the current temperature T₁.

The capacitance C changes because the junction area S₁ of the dielectric 121 is increased whereas the junction area S₂ of the vacuum space 122 is decreased in response to the increased temperature. When the dielectric constant ∈ of the dielectric 121 is greater than that ∈₀ of the vacuum space 122, the capacitance C is increased in response to the increased temperature.

The changed electric potential V results from the changed capacitance C which changed in response to the increased temperature.

Accordingly, it can be understood that the temperature change causes the capacitance to be changed and the capacitance change causes the electric potential V to be changed.

Given that the change of the capacitance C is linear to the temperature change, the current temperature T₂ may be calculated by Equation 3 or Equation 4 as follows.

$$\begin{matrix}{T}_{2} - {T}_{1} = k ( {C}_{T 2} - {C}_{T 1} ) \\ T 2 = k ( {C}_{T 2} - {C}_{T 1} ) + {T}_{1} & [ Equation 3 ] \\ {T}_{2} - {T}_{1} = k ( \frac{Q}{{V}_{T 2}} - \frac{Q}{{V}_{T 1}} ) \\ {T}_{2} = α ( \frac{1}{{V}_{T 2}} - \frac{1}{{V}_{T 1}} ) + {T}_{1} & [ Equation 4 ]\end{matrix}$$

In Equations 3 and 4, k and (where α=k×Q) are predetermined constant values, and are different in response to a structure of the capacitor 100 and a kind of the dielectric 121, and may be experimentally obtained.

The temperature calculation unit 200 may calculate the current temperature T₂ using Equation 3 or equation 4.

Based on Equation 3, the temperature calculation unit 200 detects the electric potential difference V_{T2} at the current temperature T₂, calculates the capacitance C_{T2} at the current temperature T₂ using the detected electric potential difference V_{T2}, and calculates the current temperature T₂ using the calculated capacitance C_{T2}, a known value k, the reference temperature T₁, and the capacitance C_{T1} at the reference temperature.

Alternatively, based on Equation 4, the temperature calculation unit 200 detects the electric potential difference V_{T2} at the current temperature T₂, and calculates the current temperature T₂ using the detected electric potential difference V_{T2}, a known value α, the reference temperature T₁, and the electric potential difference V_{T1} at the reference temperature.

Hereinafter, characteristics of a capacitive type temperature sensor implemented to be different from that of FIG. 1 will be described except the common description with that shown in FIG. 1.

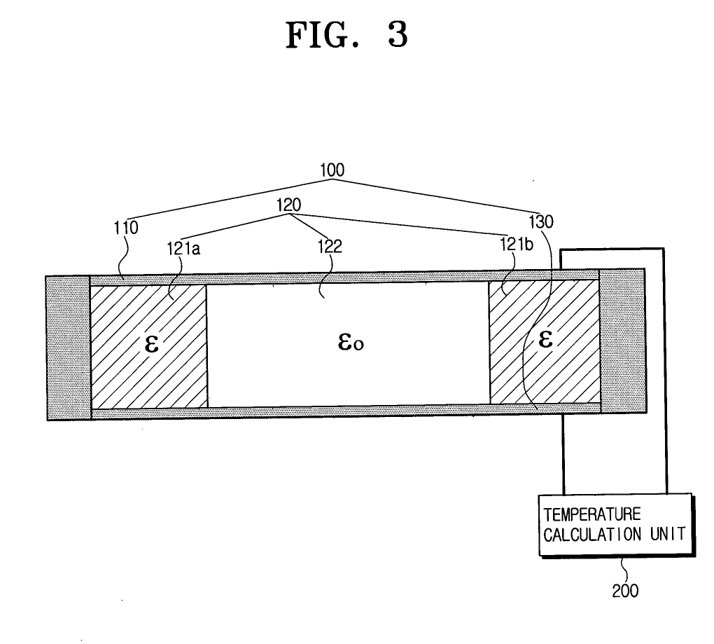

FIG. 3 is a view illustrating a capacitive type temperature sensor in accordance with another exemplary embodiment of the present invention. A structure of the dielectric layer 120 shown in FIG. 3 is different from that of the dielectric layer 120 shown in FIG. 1 in that a first dielectric 121a is positioned at a left end of the dielectric layer 120 as shown in FIG. 3, a second dielectric 121b is positioned at a right end of the dielectric layer 120, and a vacuum space 122 is positioned in a middle of the dielectric layer 120.

The first dielectric 121a positioned at the left end of the dielectric layer 120 may be a different kind of material from that of the second dielectric 121b positioned at the right end of the dielectric layer 120, but it is assumed hereinafter that both of the dielectrics are the same kind of material for simplicity of description. That is, it is regarded that the dielectric constant E of the first dielectric 121a is the same as that of the second dielectric 121b.

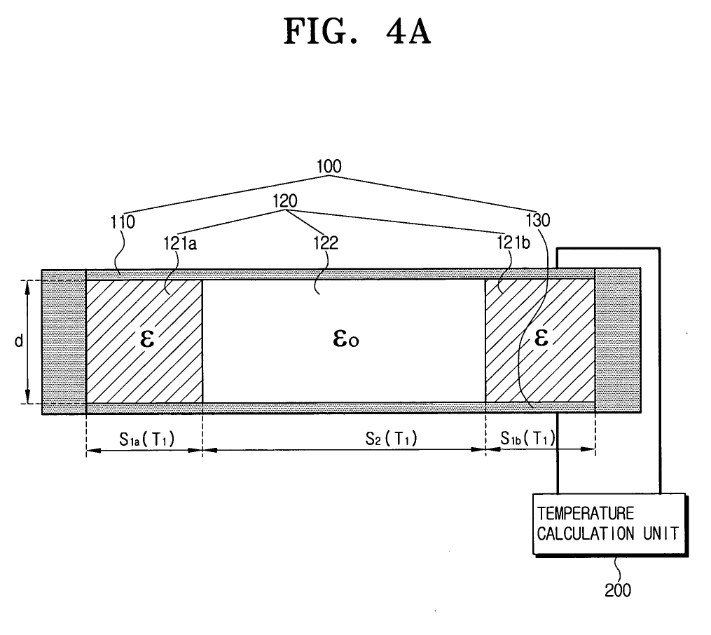

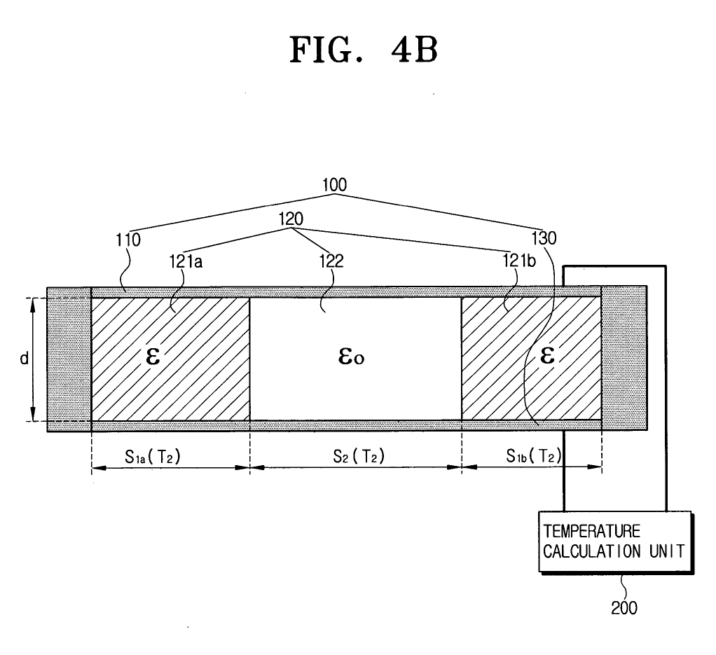

Hereinafter, a principle of calculating a temperature of the capacitive type temperature sensor shown in FIG. 3 will be described in detail with reference to FIGS. 4A and 4B.

FIG. 4A depicts the state of the present capacitive type temperature sensor at the reference temperature T₁. Referring to FIG. 4A, a length between the top electrode layer 110 and the bottom electrode layer 130 is denoted by d, a junction area of the first dielectric 121a is S₁ₐ(T₁), a junction area of the vacuum space 122 is S₂(T₁), and a junction area of the second dielectric 121b is S_{1b}(T₁), at the reference temperature T₁.

In this case, the capacitance C_{T1} and the electric potential difference V_{T1} at the reference temperature T₁ may be determined as follows in Equation 5.

$${C}_{T 1} = ɛ \frac{{S}_{1 a} ( {T}_{1} )}{d} + {ɛ}_{0} \frac{{S}_{2} ( {T}_{1} )}{d} + ɛ \frac{{S}_{1 b} ( {T}_{1} )}{d} \\ {V}_{T 1} = \frac{Q}{{C}_{T 1}} \qquad [ Equation 5 ]$$

FIG. 4B depicts the state of the present capacitive type temperature sensor when a temperature is increased from the reference temperature T₁ to the current temperature T₂ (i.e., T₂>T₁). Comparing FIG. 4A with FIG. 4B, the length d between the top and bottom electrode layers 110 and 130 is constant. However, it is noted that the junction area of the first dielectric 121a is increased to S₁ₐ(T₂) (i.e., S₁ₐ(T₂)>S₁ₐ(T₁)), the junction area of the second dielectric 121b is increased to S_{1b}(T₂) (i.e., S_{1b}(T₂)>S_{1b}(T₁)) and the junction area of the vacuum space 122 is decreased to S₂(T₂) (i.e., S₂(T₂)<S₂(T₁)).

In this case, the capacitance C_{T2} at the current temperature T₂ and the electric potential difference V_{T2} at the current temperature T₂ may be determined as follows in Equation 6.

$${C}_{T 2} = ɛ \frac{{S}_{1 a} ( {T}_{2} )}{d} + {ɛ}_{0} \frac{{S}_{2} ( {T}_{2} )}{d} + ɛ \frac{{S}_{1 b} ( {T}_{2} )}{d} \\ {V}_{T 2} = \frac{Q}{{C}_{T 2}} \qquad [ Equation 6 ]$$

When Equations 5 and 6 are compared with Equations 1 and 2, it can be understood that the degree of change of the capacitance C in response to the temperature change is greater in Equations 5 and 6 than in Equations 1 and 2. That is, the degree of change of the capacitance C in response to the temperature change of the capacitive type temperature sensor shown in FIG. 3 is greater than that of the capacitance C in response to the temperature change of the capacitive type temperature sensor shown in FIG. 1. This is because the first and second dielectrics 121a and 121b are provided in the dielectric layer 120 of the capacitive type temperature sensor as shown in FIG. 3.

The temperature calculation unit 200 may calculate the current temperature T₂ using the above-described equation 3 or equation 4. As this calculation has the same procedure as the case of the capacitive type temperature sensor shown in FIG. 1, the descriptions thereof will be omitted for brevity.

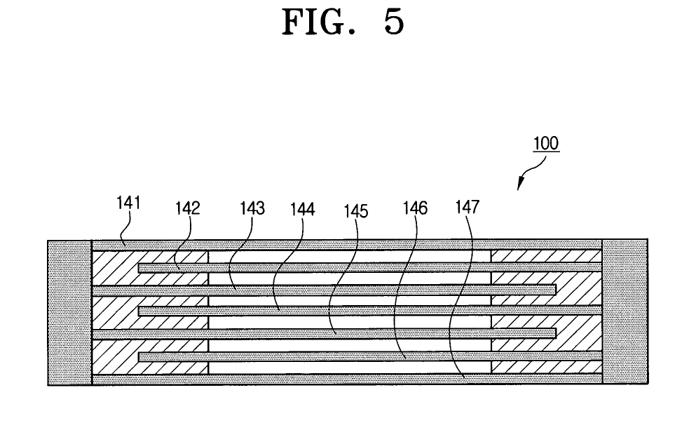

Hereinafter, a capacitive type temperature sensor implemented to be different from those of FIGS. 1 and 3 will be described with reference to FIG. 5. FIG. 5 is a view illustrating a capacitor of a capacitive type temperature sensor in accordance with still another exemplary embodiment of the present invention.

The capacitor 100 shown in FIG. 5 includes a plurality of electrode layers 141 to 147, where the degree of change of the capacitance C in response to the temperature change is increased, which allows the sensitivity of the capacitive type temperature sensor to be further enhanced. It is to be appreciated that the number of the electrode layers of the capacitor 100 is not limited to the number shown in FIG. 5.

Exemplary embodiments of the capacitive type temperature sensor utilize a principle that a capacitance of the capacitor having a dielectric is changed in response to the temperature change, wherein a volume of the dielectric is changed in response to the temperature change. The capacitive type temperature sensor according to the present invention is applicable to the MEMS, and may obtain a good effect when applied thereto.

According to the present invention, the capacitive type temperature sensor has a good sensitivity of measuring the temperature and a good accuracy thereof, and does not consume a large amount of power because it does not utilize a resistor. In addition, the capacitive type temperature sensor does not use an actuator so that a calibration and fabrication process is facilitated.

The foregoing embodiments and advantages are merely exemplary and are not to be construed as limiting the present invention. The present invention can be readily applied to other types of apparatuses. Also, the description of the exemplary embodiments of the present invention is intended to be illustrative, and not to limit the scope of the claims, and many alternatives, modifications, and variations will be apparent to those skilled in the art.

1. A temperature sensor comprising:
a first electrode layer;
a second electrode layer;
a dielectric layer which is formed at an area between the first and second electrode layers, the dielectric layer comprising a first dielectric having a volume that is changed in response to a temperature change;
a vacuum space which is formed at another area between the first and second electrode layers; and
a temperature calculation unit which calculates a temperature corresponding to an electric potential difference between the first and second electrode layers.

2. The temperature sensor as recited in claim 1, wherein a junction area between the first dielectric and the first and second electrode layers is changed in response to the volume change of the dielectric, and an electric potential difference between the first and second electrode layers is changed in response to the junction area change.

3. A temperature sensor comprising:
a first electrode layer;
a second electrode layer;
a dielectric layer which is interposed between the first and second electrode layers and comprises a first dielectric having a volume that is changed in response to a temperature change; and
a temperature calculation unit which calculates a temperature corresponding to an electric potential difference between the first and second electrode layers, wherein the volume change of the first dielectric in response to the temperature change is linear.

4. The temperature sensor as recited in claim 3, wherein the first dielectric is one of toluene, octanol, propanol, ethanol, and methanol.

5. A temperature sensor comprising:
a first electrode layer;
a second electrode layer;
a dielectric layer which is interposed between the first and second electrode layers, the dielectric layer comprising a first dielectric having a volume that is changed in response to a temperature change, a second dielectric having a volume that is changed in response to the temperature change, and a vacuum space interposed between the first and second dielectrics; and
a temperature calculation unit which calculates a temperature corresponding to an electric potential difference between the first and second electrode layers.

6. The temperature sensor as recited in claim 5, wherein a first junction area between the first dielectric and the first and second electrode layers is changed in response to the volume change of the first dielectric, a second junction area between the second dielectric and the first and second electrode layers is changed in response to the volume change of the second dielectric, and an electric potential difference between the first and second electrode layers is changed in response to the change of the first and second junction areas.

7. The temperature sensor as recited in claim 6, wherein the volume change of the first dielectric in response to the temperature change, and the volume change of the second dielectric in response to the temperature change are linear.

8. The temperature sensor as recited in claim 7, wherein the first dielectric is one of toluene, octanol, propanol, ethanol, and methanol, and the second dielectric is one of toluene, octanol, propanol, ethanol, and methanol.

9. The temperature sensor as recited in claim 1, wherein the temperature calculation unit detects an electric potential difference between the first and second electrode layers, calculates a capacitance between the first and second electrode layers using the calculated electric potential difference, and calculates a temperature corresponding to the calculated capacitance.

10. (canceled)

11. (canceled)

12. The temperature sensor as recited in claim 5, further comprising a plurality of electrodes which are provided between the first and second electrodes, and extend from the first dielectric to the second dielectric through the vacuum space.
